(19) United States
(12) Patent Application Publication
(10) Pub. No.: US 2006/0147344 A1
(43) Pub. Date: Jul. 6, 2006

(54) Fully packed capillary electrophoretic separation microchips with self-assembled silica colloidal particles in microchannels and their preparation methods

(75) Inventors: Chong H. Ahn, Cincinnati, OH (US); SeHwan Lee, Cincinnati, OH (US); Jongman Park, Gyounggi-do (KR); Shigeyoshi Horiike, Kyoto (JP); Won Kim, Gyeonggido (KR)

Correspondence Address: HAHN LOESER & PARKS, LLP, One GOJO Plaza, Suite 300, AKRON, OH, 44311-1076, US

(73) Assignee: The University of Cincinnati

(21) Appl. No.: 11/241,364

(22) Filed: Sep. 30, 2005

Related U.S. Application Data
(60) Provisional application No. 60/614,899, filed on Sep. 30, 2004.

(51) Int. Cl. G01N 30/02

(52) U.S. Cl. 422/70

(57) ABSTRACT

A novel CEC column preparation method for various forms of CEC separation using selectively or fully packed microchannels with self-assembled silica colloidal particles is disclosed. The method relies on the three dimensional uniform silica colloidal packing through selective regions or whole channels resulting in uniform EOF and reproducibility. The fully packed capillary electrophoretic separation microchip is inherently suited for a handheld system since it exploits uniquely fully packed separation channels to achieve better separation efficiency and stability. The fully packed capillary electrophoretic separation microchip can be easily fabricated using low-cost, rapid manufacturing techniques, and can provide high performance for CEC separation with various chromatographic stationary support packing, functionalized surface of packed beads. The fully packed microchannels with self-assembled silica colloidal particles can be applied for preparation of a built-in submicron filter. Embodiments of the present invention address a significant challenge in the development of disposable CEC microchips, specifically, providing a reliable solution for preparation of the CEC separation column in a device that may be immediately applied for a variety of CEC applications.

### CROSS-REFERENCE TO RELATED APPLICATIONS/INCORPORATION BY REFERENCE

This application claims priority to and the benefit of U.S. Provisional Patent Application Ser. No. 60/614,899 filed on Sep. 30, 2004 and which is incorporated herein by reference in its entirety. Also, the following Published U.S. patent applications are each incorporated herein by reference in their entirety: US 2004/0118688 Ser. No. 10/630,628 filed on Jul. 29, 2003; US 2005/0051489 Ser. No. 10/917,257 filed on Aug. 11, 2004; US 2004/0053009 Ser. No. 10/660,588 filed on Sep. 12, 2003; and US 2004/0241718 Ser. No. 10/783,564 filed on Feb. 20, 2004.

### TECHNICAL FIELD

Embodiments of the present invention generally relate to the design and fabrication of microfabricated capillary electrophoresis (CE) and capillary electro-chromatography (CEC) devices for separation of biochemical molecules of interest. More specifically, this invention relates to the development of said devices on a plastic substrate for disposable and/or point-of-care testing applications. The invention also relates to efficient, user-friendly microfabricated separation devices incorporating partially and/or fully packed microchannels with self-assembled particle structures.

Also disclosed is a technique for exploiting the advantages of CE and CEC on a common platform to develop a superior separation technique and devices based on this technique. The said technique allows different forms of CE and CEC based separations, including but not limited to reversed-phase, normal-phase, adsorption, size-exclusion, affinity, and ion chromatography.

### BACKGROUND OF THE INVENTION

Capillary electrophoresis (CE) is an electrophoretic separation technique where sample components move under the influence of the electrical field through a capillary tube or microfabricated channel. Capillary electrophoresis has garnered increasing interest owing the excellent separation results achieved as a result of the inherently high surface area to volume ratios associated with the narrow diameter capillaries; an advantage that is further enhanced in microfabricated flow channels owing to their smaller dimensions. An added benefit of microfabricated separation devices is the rapid heat dispersion generated from Joule heating; thereby leading to improved performance. Thus, capillaries can tolerate voltages far higher than those used for conventional electrophoresis systems. This translates into significant savings in time and increased separation efficiencies. CE is most often carried out in fused silica capillaries where under normal buffer conditions the silanol groups on the walls of the capillaries are ionized. The surface charge of the capillary is neutralized by buffer components. In the presence of an electrical field, the silanol groups are immobile but the neutralizing buffer components migrate toward the electrode having an opposite charge. As a result, there is a net migration of species within the capillary that may cause the migration of neutral species and some negatively charged species toward the anode. This flow is said to be caused by the electroosmotic force (EOF). The magnitude of the EOF is dictated by the zeta potential, that is, the difference in electrical potential of the capillary surface and the boundary layer of buffer. The chemical composition of the capillary wall, the pH and ionic strength of the buffer solution, and the temperature all play a role in the magnitude of the zeta potential. In addition to its generation of the EOF, analyte molecules may stick to the surface of an ionized capillary through ionic interactions. As described in US 20040118688A1, incorporated herein in its entirety by reference; non-specific ionic interactions are particularly problematic with protein solutions.

There are various electrophoretic separation techniques commonly known in the art that employ the general electrophoretic method as disclosed in US 20040241718A1, US 20040118688A1, and US 20050051489A1, incorporated herein in their entirety by reference. Capillary Zone electrophoresis (CZE), also known as free solution CE (FSCE), is the simplest form of CE. The separation mechanism is based on differences in the charge to mass ratio of the analytes. The separation relies principally on the pH-controlled ionization of the analyte and the friction of the ionized analyte as it migrates through the buffer solution as described in US 20040118688A1, incorporated herein in its entirety by reference.

Capillary Electrochromatography (CEC) is a hybrid separation method that couples the high separation efficiency of CZE with liquid chromatography using an electric field rather than hydraulic pressure to propel the mobile phase through the capillary. Since there is minimal backpressure, it is possible to use small diameter packing and achieve very high efficiencies. Alternatively, the capillary surface itself may self as the solid phase. Separation is achieved by both electrophoretic mobility and partitioning between the stationary and mobile phases.

Capillary electrophoresis (CE) offers several advantages over other electrophoretic-based separation techniques. These advantages include: (i) capillaries have high surface-to-volume ratios which permit more efficient heat dissipation which, in turn, permit high voltages to be used for more rapid separations; (ii) the technique requires minimal sample volumes; (iii) high resolution of most analytes is attainable; and (iv) the technique is suited to automation as described by Grossman et al (Grossman, P. D. and Colburn J. C. “Capillary Electrophoresis: Theory and Practice,” Academic Press, 1992) and Camilleri et al (Camilleri, P. “Capillary Electrophoresis: Theory and Practice,” CRC Press, 1993).

In part due to these and other advantages, there has been great interest in applying CE to the separation of biochemically relevant molecules; for example in protein isolation and identification operations and in nucleic acid analysis. The need for rapid and accurate separation of nucleic acids, particularly deoxyribonucleic acid (DNA), arises, in one example, in the analysis of polymerase chain reaction (PCR) products and DNA sequencing fragment analysis (see e.g., Drossman, H., Luckey, J. A., Kostichka, A. J., Cunha, J. D., and Smith, L. M., “High-speed separation of DNA sequencing reactions,” Anal. Chem., 1990, 62, 900-903.; Gestland. S. H., “Capillary gel electrophoresis for rapid, high resolution DNA sequencing,” Nucleic Acids Res., 1990 Mar. 25; 18(6): 1415-9.; Mathies, R. A. and Huang. X. C., “Capillary array electrophoresis: An approach to high-speed, high-throughput DNA sequencing”, 1992, Nature 359: 167-168).

US 20040241718A1, incorporated herein in its entirety by reference, describes a variation on general electrophoretic method is electrochromatography (EC). Generally, in EC, retention of solute by some form of stationary retentive phase provides the selectivity for separation, as in the case for a normal chromatographic separation. However, in EC, the fluid-mediated transport of solute is via electroosmotic flow, which is provided by the support material that holds the retentive phase. The interest in EC stems in part from the beliefs that zone broadening is generally smaller because the flow profile is uniform, and that flow can be achieved with smaller particles. Uniform flow profiles and smaller particles can lead to higher resolution; this resolution can be desirable in complex analysis or in situations in which the zone width can be compromised to run at faster analysis time. Uniform flow profiles are in contrast with the parabolic flow profile found in pressure-driven flow from a pump-driven packed bed chromatographic system. In pressure-driven systems, small particles can cause large pressure drops in the packed bed and can lead to pump fatigue and shorter column lifetime.

In CE, as in other techniques that work by electrophoresis and/or electroosmosis, molecules migrate under the influence of an applied electric field. This current is proportional to the cross-sectional area of the column through which transport takes place. Thus, capillary-sized columns can be used in capillary electrochromatography (CEC) because a low cross-sectional column area produces the lowest amount of heat (which can adversely affect the integrity of the molecules to be separated and can reduce the separation efficiency, due to formation of viscosity gradients). Capillary-sized columns can also be desirable because the high surface area-to-volume ratio of capillaries allows heat to be dissipated at a faster rate than heat dissipation can be achieved with larger sized columns. (from P.2)

As described in US 20040241718A1, incorporated herein in its entirety by reference; in addition to performing analytical and/or preparative techniques (e.g. separations) using columns, microfluidics devices can also be employed. For example, applications of microfluidics include, but are not limited to (a) the transportation and delivery of analytes and reagents; (b) the capture and recovery of target molecules, the removal of undesirable sample components, and the isolation and pre-concentration of analytes; and (c) hybridization detection, mutation analysis, affinity capture, and directed proteomics using matrices containing oligonucleotides such as hybridization probes, aptamers, and/or genetic DNA. As such, there is considerable overlap between the techniques of CE, CEC, and EC, and microfluidics, with microfluidics providing a platform for performing analytical and/or preparative manipulations that can be analogous to capillary methods but on a small scale and with much less reagent usage.

Microchip electrophoresis platforms emerged when the effort towards miniaturization of capillary electrophoresis was achieved in 1992 by Manz et al. (Manz, A., D. J. Harrison, E. M. J. Verpoorte, J. C. Fettinger, A. Paulus, H. Ludi, and H. M. Widmer. 1992. “Planar chips technology for miniaturization and integration of separation techniques into monitoring systems-capillary electrophoresis on a chip.” J. Chromatogr. 593:253-258). Although the principle of the electrophoresis assay remains unchanged, the microchip system is drastically different from its parental capillary system. On the microchip platform, the separation channels and the sample injection channels, as well as sample preparation and/or pre or post column reactors, can all be microfabricated on a planar substrate sealed with a cover plate; therefore, manipulation of multiple functions could be achieved on a single platform. To perform a separation, the appropriate buffer and sample/reagents are loaded onto the CE chip using hydraulic pressure from a syringe pump. Normally, a negative pressure is applied at one port of the CE or CEC microchip and liquid at the other inlets is sucked into the chip. However, this process is susceptible to the formation of micro-bubble due to cavitations in the liquid column, which renders the device useless. Then an injection voltage of several hundred volts is first applied across the sample and sample waste reservoirs to migrate the sample to the injection cross. A separation voltage is then applied to the separation channel, which induces separation of the analyte zones before they reach the detection window several centimeters downstream from the injection cross. The typical characteristic with microchip electrophoresis separation is high speed, normally 4 to 10 fold faster than conventional CE. If parallel processing is performed, then the sample analysis throughput is further increased. Other advantages with microchips are simplicity, the capability of integrating multiple functions, and potential automation as discussed in US 20040118688A1, incorporated herein in its entirety by reference.

The separation of cells and biological samples is routinely achieved in the laboratory using large, expensive flow cytometers, Coulter counters, or laborious manual sorting methods. US 20040118688A1, incorporated herein in its entirety by reference, also states that the detection of biological threat agents, infectious agents, and purity analysis, however, is best performed outside of the laboratory at the site of analysis. Thus there is a need for a rapid and accurate separation device that is mobile and ideally hand-held.

As mentioned previously, amongst the first demonstration of capillary electrophoresis on a glass chip was reported by Harrison et al (D. J. Harrison, A. Manz, Z. Fan, H. Lüdi, H. M. Widmer, Analytical Chemistry 1992, 64, 1926-1932). A complex manifold of capillary channels were fabricated on a planar glass substrate by using micromachining technique. The possibility of separation of fluorescein and calcein mixture was demonstrated utilizing electrokinetic phenomena.

After then, numerous developments and applications based on capillary electrophoretic microchip have been reported; for example in P.-A. Auroux, D. Iossifidis, D. R. Reyes, A. Manz, Analytical Chemistry, 2002, 74, 2637-2652, J. P. Landers, Analytical Chemistry, 2003, 75, 2919-2927, and L. Zhang, F. Dang, Y. Baba, Journal of Pharmaceutical and Biomedical Analysis, 2003, 30, 1645-1654, and H. D. Willauer, G. E. Collins, Electrophoresis, 2003, 24, 2193-2207).

However, the efforts to date have utilized “unpacked” microchannel structures, which show low reproducibility in electroosmotic flows because of large cross sectional area and possibility of contamination of the wall of microchannels.

It is an established fact that in order to get reliable data from microfabricated separation devices, the microchips have to be cleaned and conditioned carefully prior to use.

Furthermore, great care needs to be exercised during loading of the chips using negative pressures to avoid the formation of micro-bubbles in the liquid columns.

Furthermore, all solutions need to be filtered with sub-micron filters before use to avoid the possibility of contamination.

Furthermore, the microchips have to be positioned very carefully in order to minimize the pressure differences between the reservoirs caused by gravitational forces.

Furthermore, the microchip operation must be conducted in a controlled environment which should be free from any shocks or vibrations that may disturb normal electroosmotic flows.

The preceding discussion provides only a partial list of some of the drawbacks of CE and microfabricated CE devices which restrict their use in real on-site applications.

US 20040241718A1, incorporated herein in its entirety by reference, describes an approach to overcome some of the above listed drawbacks. US 20040241718A1 describes non-packed capillaries are employed for creating a stationary phase in a capillary for CEC and capillary chromatography. In this method, a stationary phase reagent (such as an aptamer) is covalently attached to the inner surface of a capillary to form a stationary phase monolayer. One drawback of this method is that solutes must diffuse to the surface in order to interact with the stationary phase.

Recently Lazar et al (I. M. Lazar, L. Li, Y. Yang, B. L. Karger, Electrophoresis, 2003, 24, 3655-3662) have demonstrated fabrication techniques for the fabrication of a microporous monolithic polymeric gel in situ within a microchannel on a glass microchip. This work establishes that more uniform and controllable electroosmotic flow is obtained through packed channels compared to unpacked channels resulting in improved sample manipulations.

US 20040241718A1 also discloses a technique, wherein capillaries are packed with packing particles, such as silica microspheres that can be coated with a stationary phase reagent, such as an aptamer. This approach is commonly employed in high performance liquid chromatography (HPLC). However, unlike the wide stainless steel columns used in HPLC, it is difficult to devise a way to retain the packing particles in a narrow silica capillary. Thus, a drawback of this method is that typically a retaining frit must be installed in the capillary to retain the packing material within the capillary. This is not a trivial consideration, since frit design, fitting, and installation are not routine operations.

Meanwhile, utilization of self-assembled colloidal thin layer packing using submicron silica particles has been an issue of considerable interest for the development of photonic band gap crystals (S. M. Yang, G. A. Ozin, Chemical Communications, 2000, 2507-2508). US 20040053009A1, incorporated herein in its entirety by reference, discloses techniques for three dimensional self assembly of silica microspheres for optical applications. However, three dimensional self-assembled packing of submicron colloidal silica particles for microfabricated separation devices has not yet been envisaged. Furthermore, the techniques of US 20040053009A1 are not amenable to selective localized self-assembly of the microsphere array.

The preceding discussion highlights some of the issues that plague the successful development of microfabricated CE, CEC and other electrophoretic separation techniques towards real-world application. The present invention seeks to address one or more of the issues discussed above to realize an efficient, robust and user-friendly microfabricated separation system that retains the advantages of the previously discussed microfabricated separation devices, while adding benefit by solving the problems listed above.

### SUMMARY OF THE INVENTION

Recently, a fabrication process and separation technique that is suitable for such an approach has been described by Horiike et al (S. Horiike, S. H. Lee, T. Nishimoto and C. H. Ahn, “Self-Assembly of Colloids for Plastic Capillary Electrochromatography Chip,” Proceedings of the 7th International Conference on Micro Total Analysis Systems (micro-TAS 2003), California, USA, Oct. 5-9, 2003, p. 417-420) and Han et al (J. Han, S. H. Lee and C. H. Ahn, “An On-Chip Blood Serum Separator Using Self-Assembled Microsphere Filter,” Proceedings of the 14th International Conference on Solid-State Sensors, Actuators and Microsystems (Transducers' 05), Seoul, Korea, Jun. 5-9, 2005, pp. 1688-1691) and also in Takemori et al (Y. Takemori, S. Horiike, T. Nishimoto, H. Nakanishi and T. Yoshida, “High Pressure Electroosmotic Pump Packed with Uniform Silica Nanospheres,” Proceedings of the 14th International Conference on Solid-State Sensors, Actuators and Microsystems (Transducers' 05), Seoul, Korea, Jun. 5-9, 2005, pp. 1573-1775).

A polymer or plastic microfabricated separation chip is disclosed, that in accordance with an embodiment of the present invention, wherein selective regions of the microchannels are packed with silica microspheres. The packing of micron sized or sub-micron sized particles within the microchannels significantly enhances the separation efficiency of the device. In one embodiment of the invention, a self-assembled microsphere array is created by selective surface modification of the plastic substrate followed by ordered self-assembly of sub-micron particles in regions of the microchannels exhibiting higher surface energy than the adjoining regions. The use of selective surface modification allows easy control over the area and/or length of the packed bead column thereby offering tremendous flexibility for microchip design.

Further disclosed here are technique to fill the separation channel using a self-assembly submicron silica colloidal particles. The self-assembly method is ideally suited towards various forms of CEC separation devices and can be easily controlled by changing packing material, functionalizing the surface of packing material, and pre-derivatized chromatographic stationary phase

In another embodiment, the entire microchannel network is “packed” using the self-assembly technique disclosed in US 20040053009A1. The self-assembled bead column is then used for CEC applications leading to improved results and performance characteristics as described later in this disclosure.

In this description, the terms plastic and polymer; as defined later in this disclosure; are used interchangeably.

Disclosed herein is a selective three dimensional self-assembly bead packing technique for preparation of CE and/or CEC separation column.

Furthermore, disclosed herein is the use of techniques used for CE, CEC separation using fully packed capillary electrophoretic separation microchip with self-assembled submicron silica colloidal particles in microchannels.

Without intent of limiting the scope of the present invention, certain embodiments of the present invention are generally low-cost, disposable plastic microchips for the analysis of biochemical molecules using CE and/or CEC based separation techniques. It will be apparent from the disclosure that the present invention is not limited in terms of scope of application to a particular class or group of biochemical molecules; and indeed may be applied for the separation and subsequent detection of virtually any molecules that can separated and detected using conventional CE and/or CEC techniques.

Certain embodiments of the present invention overcome the deficiencies and inadequacies in the prior art as described in the previous section and as generally well known in the industry.

Certain embodiments of the present invention overcome many of the disadvantages of the prior art by providing various different stationary phases to allow performance of different forms of CE and/or CEC separations.

Certain embodiments of the present invention allow for uniform EOF both in terms of velocity and uniformity resulting in rapid and improved separation.

Certain embodiments of the present invention allow for high interaction between aqueous buffer solution and surface of the packing materials by achieving extremely high surface-to-volume ratio by colloidal packing of micron and/or submicron particles in microchannels.

Certain embodiments of the present invention offer higher reproducibility in the separation process by minimizing the chance of micro-bubble formation due to negative pressures.

Certain embodiments of the present invention offer higher reproducibility in CE and/or CEC separation by eliminating the effects of pressure difference caused by gravitational forces.

Certain embodiments of the present invention offer faster separation processes using CE and/or CEC techniques by using a higher applied potential.

Certain embodiments of the present invention provide improved performance with higher tolerance for external shocks or vibrations.

Certain embodiments of the present invention offer improved performance of CE and/or CEC separations by tailoring the choice of materials for the stationary phase to the desired separation process.

Certain embodiments of the present invention offer improved performance of CE and/or CEC separations by modifying the packed particle dimensions to the desired separation process.

Certain embodiments of the present invention make it feasible to develop low-cost, disposable microfabricated devices using plastic substrates.

Certain embodiments of the present invention provide the ability to develop low-cost, disposable microfabricated separation devices for point-of-care testing applications.

Certain embodiments of the present invention provide the ability to develop a generic platform for CE and/or CEC separations that can be adapted for a particular separation/detection process without considerable effort.

Certain embodiments of the present invention allow for the development of pre-conditioned separation microchips thereby minimizing the sample prep times required during actual tests.

Certain embodiments of the present invention allow for the use of complex biological fluids with extracellular matrices; e.g. blood; owing the inherent filtering action of the self-assembled bead column thereby further minimizing the sample prep requirements.

Other embodiments, features and advantages of the present invention will become apparent from the detailed description of the present invention when considered in conjunction with the accompanying drawings.

### BRIEF DISCRIPTION OF THE DRAWINGS

The present invention, as defined in the claims, can be better understood with reference to the following drawings and microphotographs of the actual devices. The drawings are not all necessarily drawn to scale, emphasis instead being placed upon clearly illustrating principles of the present invention.

FIGS. 1a-1b are schematic illustrations of the fully packed capillary electrophoretic separation microchip with self-assembled silica colloidal particles in a localized region of the microchannels in accordance with an embodiment of the present invention.

FIGS. 2a-2g show schematic sketches illustrating the selective self-assembly method, in accordance with an embodiment of the present invention.

FIGS. 3a-3d show schematic sketches illustrating the self-assembly method for fully-packed microchannels, in accordance with an embodiment of the present invention.

FIGS. 4a-4b show schematic sketches illustrating the loading sequence or pre-conditioning sequence of the fully-packed microfabricated separation chip, in accordance with an embodiment of the present invention.

FIGS. 5a-5d show a schematic operational sequence of the fully packed microfabricated separation chip, in accordance with an embodiment of the present invention.

FIGS. 6a-6b show voltage-flow rate and pressure-flow rate characterization results using different packing conditions, in accordance with an embodiment of the present invention.

FIG. 7 shows typical electropherograms showing reproducible result of the fully packed capillary electrophoretic separation microchip with self-assembled silica colloidal particles in microchannels, in accordance with an embodiment of the present invention.

FIG. 8 shows typical electhopherogram showing separation result of the fully packed capillary electrophoretic separation microchip with self-assembled silica colloidal particles in microchannels, in accordance with an embodiment of the present invention.

FIGS. 9a-9d show microphotographs and SEM images of the actual fabricated device, in accordance with an embodiment of the present invention.

### DETAILED DISCRIPTION OF THE INVENTION

Broadly stated, certain embodiments of the present invention provide a capillary electrophoretic separation microchip, fully packed with micron or sub-micron particles using self-assembled silica colloidal particles in microchannels. The use of a packed channel configuration is envisaged to present significant advantages in terms of operational characteristics improvement and use of microfabricated separation devices for point-of-care applications. Embodiments of the present invention use a self-assembly method for preparation of CEC separation column on demand.

A key concept disclosed herein is the use of a selectively or fully packed separation column that has a three dimensional uniform colloidal silica packing in micro scale channels to allow performance of different forms of CEC, including but not limited to reversed-phase, normal-phase, adsorption, size-exclusion, affinity, and ion chromatography.

Definitions

The process of “Microfabrication” as described herein relates to the process used for manufacture of micrometer sized features on a variety of substrates using standard microfabrication techniques as understood widely by those skilled in this art. The process of microfabrication typically involves a combination of processes such as photolithography, wet etching, dry etching, electroplating, laser ablation, chemical deposition, plasma deposition, surface modification, injection molding, hot embossing, thermoplastic fusion bonding, low temperature bonding using adhesives and other processes commonly used for manufacture of MEMS (microelectromechanical systems) or semiconductor devices. “Microfabricated” or “microfabricated devices” as referred to herein refer to the patterns or devices manufactured using the microfabrication technology.

The term “BioMEMS” as used herein describes device fabricated using MEMS techniques specifically applied towards biochemical applications. Such applications may include detection, sample preparation, purification, isolation etc. and are generally well know to those skilled in the art. One such technique that is commonly used in BioMEMS applications is that of “Capillary Electrophoresis” (CE). CE refers to the process wherein an electrical field is applied across a liquid column leading to the separation of its constituents based on their mass/charge ratio. The term “CE Chips” refers to microfluidic BioMEMS devices specifically used for CE applications.

The term “chip”, “microchip”, or “microfluidic chip” as used herein means a microfluidic device generally containing a multitude of microchannels and chambers that may or may not be interconnected with each another. Typically, such biochips include a multitude of active or passive components such as microchannels, microvalves, micropumps, biosensors, ports, flow conduits, filters, fluidic interconnections, electrical interconnects, microelectrodes, and related control systems. More specifically the term “biochip” is used to define a chip that is used for detection of biochemically relevant parameters from a liquid or gaseous sample. The microfluidic system of the biochip regulates the motion of the liquids or gases on the biochip and generally provides flow control with the aim of interaction with the analytical components, such as biosensors, for analysis of the required parameter.

The term “microchannel” as used herein refers to a groove or plurality of grooves created on a suitable substrate with at least one of the dimensions of the groove in the micrometer range. Microchannel can have widths, lengths, and/or depths ranging from 1 μm to 1000 μm. It should be noted that the terms “channel” and “microchannel” are used interchangeably in this description. Microchannels can be used as stand-alone units or in conjunction with other microchannels to form a network of channels with a plurality of flow paths and intersections.

The term “microfluidic” generally refers to the use of microchannels for transport of liquids or gases. The microfluidic system consists of a multitude of microchannels forming a network and associated flow control components such as pumps, valves and filters. Microfluidic systems are ideally suited for controlling minute volume of liquids or gases. Typically, microfluidic systems can be designed to handle fluid volumes ranging from the picoliter to the milliliter range.

The term “substrate” as used herein refers to the structural component used for fabrication of the micrometer sized features using microfabrication techniques. A wide variety of substrate materials are commonly used for microfabrication including, but not limited to; silicon, glass, polymers, plastics, ceramics to name a few. The substrate material may be transparent or opaque, dimensionally rigid, semi-rigid or flexible, as per the application they are used for. Generally, microfluidic devices consist of at least two substrate layers where one of the faces of one substrate layer contains the microchannels and one face of the second substrate layer is used to seal the microchannels. The terms “substrate” and “layer” are used interchangeably in this description.

The term “UV-LIGA” describes a photolithography process modeled on the “LIGA” fabrication approach. LIGA refers to the microfabrication process for creating microstructures with high aspect ratio using synchrotron radiation and thick photoresists (ranging in film thickness from 1 μm to 5 mm). The LIGA process is used to form a template that can be used directly or further processed using techniques such as electroplating to create the microfluidic template. UV-LIGA uses modified photoresists that can be spin coated in thicknesses of 1 μm to 1 mm and are sensitive to UV radiation. UV radiation sources are commonly used in microfabrication facilities and hence UV-LIGA offers a lower cost alternative to LIGA for fabrication of high aspect ratio microstructures.

The term “master mold” as used herein refers to a replication template, typically manufactured on a metallic or Silicon substrate. The features of the master mold are fabricated using the UV-LIGA and other microfabrication processes. The microstructures created on the master mold may be of the same material as the master mold substrate e.g. Nickel microstructures on a Nickel substrate or may be a dissimilar material e.g. photoresist on a Silicon surface. The master mold is typically used for creating microfluidic patterns on a polymer substrate using techniques such as hot embossing, injection molding, and casting.

The term “bonding” as used herein refers to the process of joining at least two substrates, at least one of which has microfabricated structures e.g. microchannel, on its surface to form a robust bond between the two substrates such that any liquid introduced in the microchannel is confined within the channel structure. A variety of techniques can be used to bond the two substrate including thermoplastic fusion bonding, liquid adhesive assisted bonding, use of interfacial tape layers etc. Specifically in this description the terms “bonding” and “thermoplastic fusion bonding” are used interchangeably. Thermoplastic fusion bonding involves heating the two substrates to be joined to their glass transition temperature and applying pressure on the two substrates to force them into intimate contact and cause bond formation. Another bonding process, namely the use of UV-adhesive assisted low temperature bonding, is also described herein and is specifically and completely referred to in all occurrences.

As used herein, the terms “amino acid” mean any of the twenty naturally occurring amino acids. An amino acid is formed upon chemical digestion (hydrolysis) of a polypeptide at its peptide linkages. Amino acids are commonly a target for CE and/or CEC based separation devices in order to identify the various amino acids or polypeptides which are constituted of multiple amino acid groups. The terms “protein”, “polypeptide” and “peptide” are used interchangeably

The term “detection technique” as used herein refers to a multitude of detection approaches commonly known to those skilled in the art. More specifically, for this invention detection techniques include optical and electrochemical detection.

The term “fluorescent detection” refers to a process wherein, excitation is supplied in form of optical energy to a particular molecule which will then absorb the energy and subsequently release the energy at another wavelength. The fluorescent detection technique requires the use of an excitation source, excitation filter, detection filter and detector. The term “chemiluminescence” refers to a process wherein certain molecules when catalyzed in presence of an enzyme, undergo a specific biochemical reaction and emit light at a particular wavelength as a result of this reaction. Chemiluminescent detection techniques only require a detector without the need for an excitation source or filters.

The term “Plasma modification” or “surface modification” as used herein, refers to addition or removal of active functional groups at the surface of a polymeric substrate. Plasma is generated by processing gas into an excited state by application of radio waves under high vacuum. Exposure of the plastic to the excited gas causes deposition of the gas molecules onto the surface of the plastic and/or chain scission leading to replacement of active functional groups; e.g. from —CH₃ to —CF₃ using a Fluorine plasma.

The intent of defining the terms stated above is to clarify their use in this description and does not explicitly or implicitly limit the application of the present invention by modifications or variations in perception of the definitions.

Fully Packed Capillary Electrophoretic Separation Microchips with Self-Assembled Silica Colloidal Particles in Microchannels and their Preparation Methods

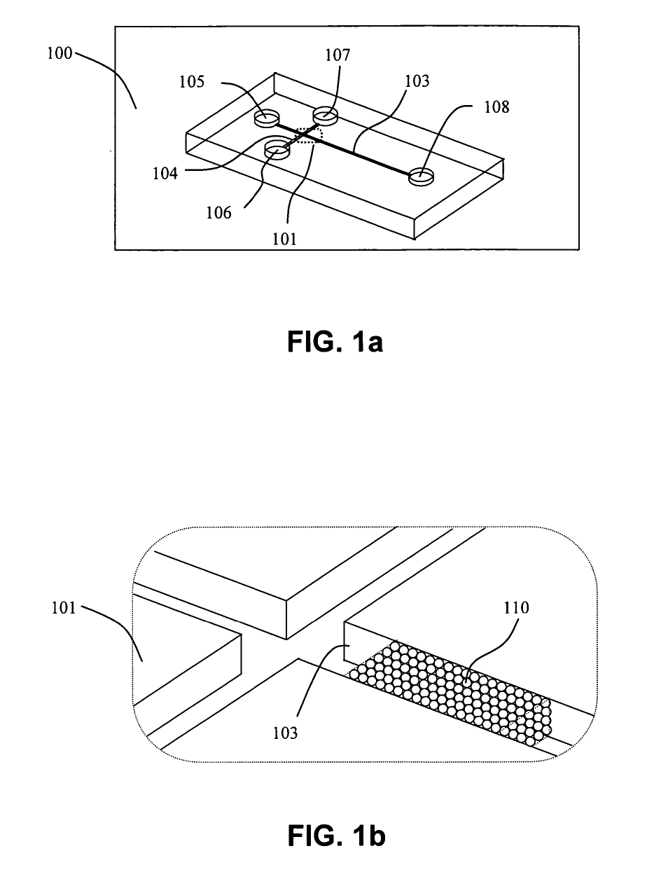

FIG. 1a shows a schematic sketch of a cross-type microfabricated separation device such as a CE chip 100. This invention discloses the use of localized and/or fully packed self assembled bead array within the microchannels. The chip as discussed in this invention has a structure similar to the one shown in FIG. 1a with key differences in the separation channel 103 and/or injection channels 104 in terms of selective or complete bead packing. The chip typically has a buffer reservoir 105, a sample reservoir 106, sample waste reservoir 107, and a waste reservoir 108. The intersection or cross-junction region 101 is expanded and shown in FIG. 1b. FIG. 1b illustrates a selectively packed separation chip wherein a three dimensional self-assembled bead array 110 is localized to certain regions of the separation channel 103.

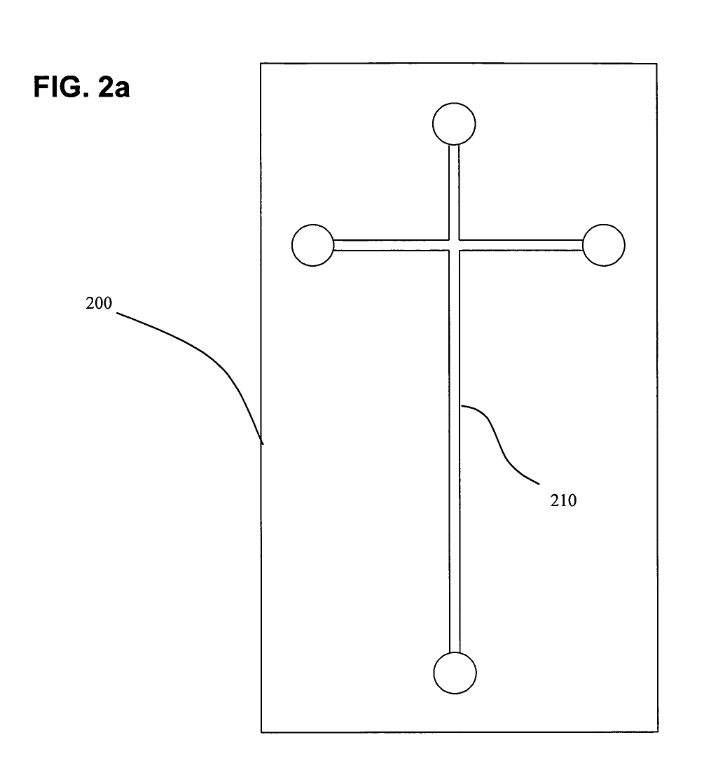

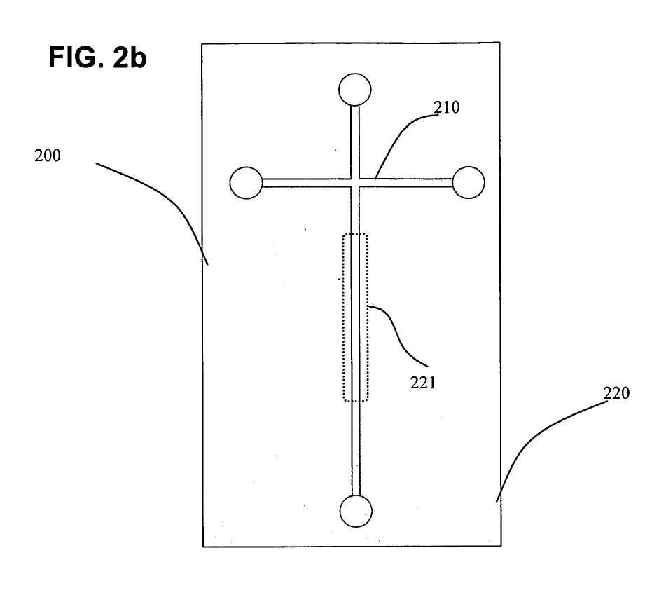

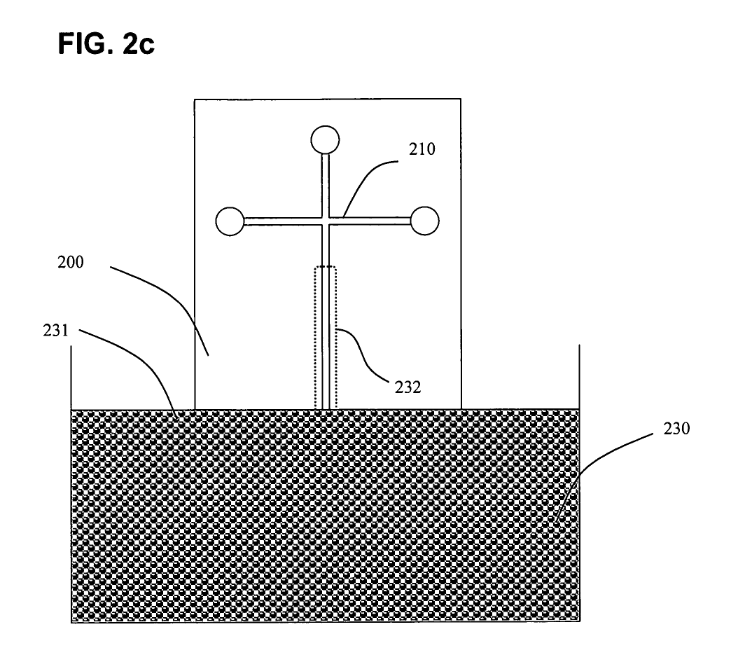

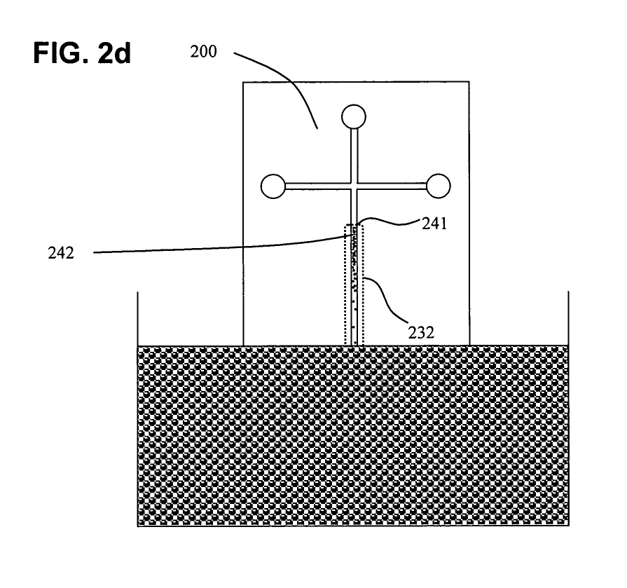

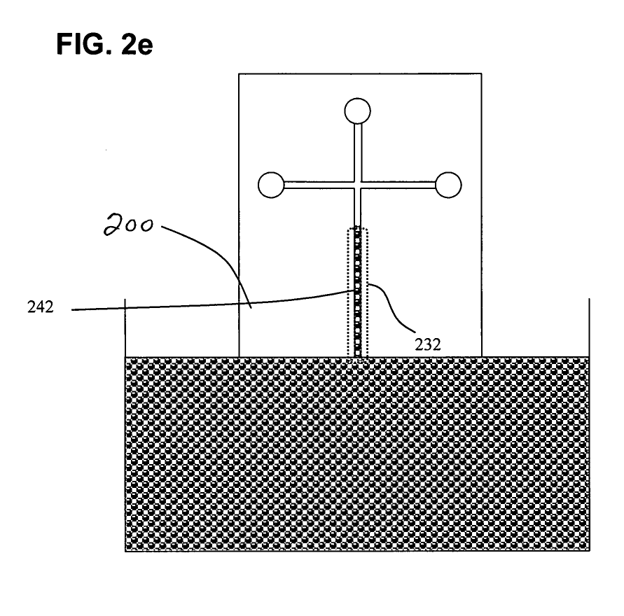

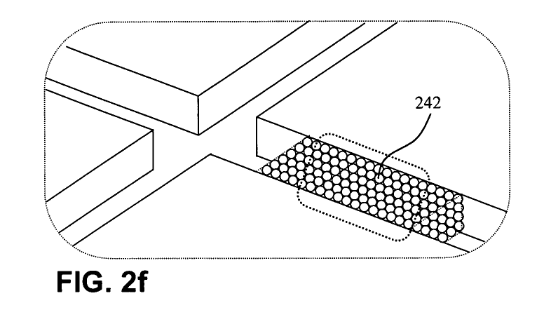

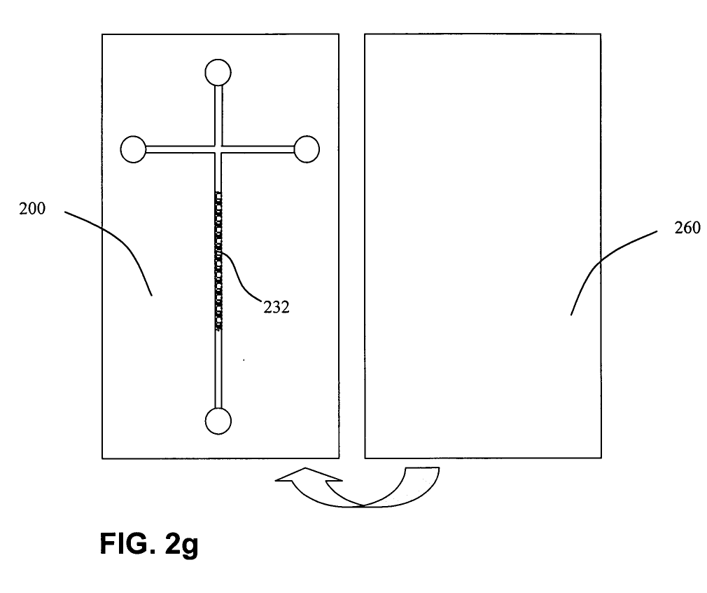

FIGS. 2a-2g schematically illustrate the fabrication sequence of the microfabricated CE and/or CEC chip. A microchannel network 210 is fabricated onto a plastic substrate using widely known techniques in the art such as hot embossing or injection molding using a suitable master mold. In this embodiment, the plastic material of the substrate is COC (Cyclic Olefin Copolymer) although any other biocompatible thermoplastic material (such as Poly-Methylmethaacrylate or Polycarbonate etc.) can be substituted. The entire microfabricated chip 200, is exposed to a CF₄/Ar (Carbon Tetrafluoride/Argon) plasma to render the surface hydrophobic. As is well known in the art, a variety of other gases (e.g. SF₆—sulfur hexafluoride) can also be used to render the surface hydrophobic or even use of other deposition techniques such as flame deposition or CVD etc. can be used for rendering the surface hydrophobic by adding desired functional groups on the surface. The intent of the description above is not to limit the invention to a particular technique; rather to convey the intent of the techniques—that is to render the entire surface of the fabricated plastic chip to a stable, strongly hydrophobic state. Indeed, if the polymer material has naturally high hydrophobicity this step can be avoided altogether.

FIG. 2b shows a schematic of the mask 220 used for selective 2^{nd} step plasma treatment. The polymer chip (treated hydrophobic) is exposed to Argon or Oxygen plasma through the opening 221 in a selected area. Thus, only the exposed microchannel region is rendered hydrophilic while the remaining channel network 210 retains the hydrophobic characteristics.

As shown in FIG. 2c; aqueous colloid 230 of monodispersed silica spheres 231 (400, 600 and 800 nm, 0.5 wt %) is heated to 50-60° C. in a beaker with gentle stirring to prevent slow precipitation of the silica particles. The longer end of the microchannels is dipped cautiously in the suspension by holding with a custom designed jig. The chip is dipped into the suspension solution until the lower end of the hydrophilic treated channels 232 is in contact with the solution. The beaker is covered to reduce evaporation of water.

As shown in the schematic of FIG. 2d, plasma treated open microchannels with hydrophilic surface regions 232 exhibit strong capillary action causing the silica colloidal suspension to be wicked up to the top of the hydrophilic treated region 241. Once the colloidal suspension reaches the top of the hydrophilic treated region within the microchannels, spontaneous three dimensional packing of the silica particles 242 starts from the top end of the microchannel due to the evaporation of water.

As shown in FIG. 2e, this self-assembly packing process of silica microspheres 242 continues toward the end of empty microchannel at the bottom. When the self-assembled packing is achieved in the desired channel area 232, the packing process is stopped.

The chip is then washed very gently with plenty of de-ionized water to clean the surface and to remove extra silica particles at dipped area. A schematic illustration of the self-assembled three dimensional bead arrays is shown in FIG. 2f. The chip with self assembled bead arrays (selective or over the entire channel network) is also referred to as the “packed chip” in this disclosure. The packed chip is completely dried at room temperature. The chip 200 is then sealed with plain COC sheet 260 by thermoplastic fusion bonding techniques, which are well known in the art as shown in FIG. 2g. The reservoirs for sample and buffer solutions are drilled with a small milling bit at the end of the channels. The reservoirs are treated with oxygen plasma to make them hydrophilic for better retention of aqueous solutions.

In accordance with an embodiment of the present invention, the suspension solution is composed of silica microparticles suspended in an aqueous solution. It is clear from the above description that this is by no means the only possible combination of suspended particles or liquid medium. For example, silica microparticles can also be dispersed in a solvent such as acetone, methanol or isopropanol. Furthermore, either aqueous or non-polar solvents can be used in conjunction with other types of particle systems such as polystyrene beads provided that the liquid medium is not detrimental to the particles. An important requirement for the assembled bead structure is exhibition of a strongly hydrophilic surface to maximize the advantages of this invention and a number of variations to the above described are possible within these parameters.

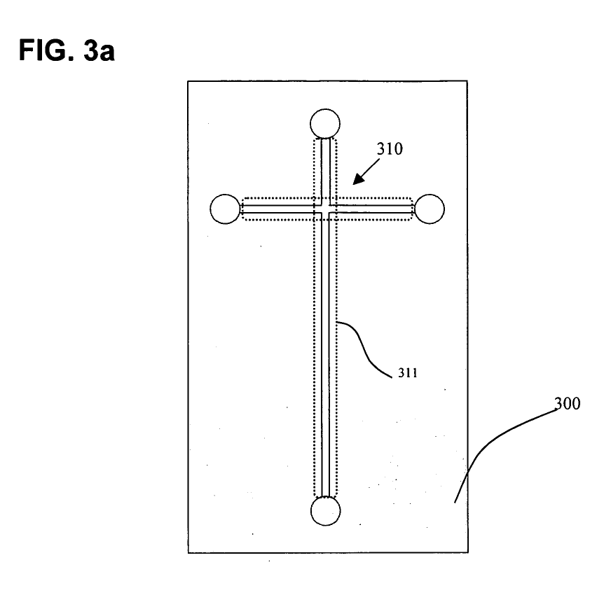

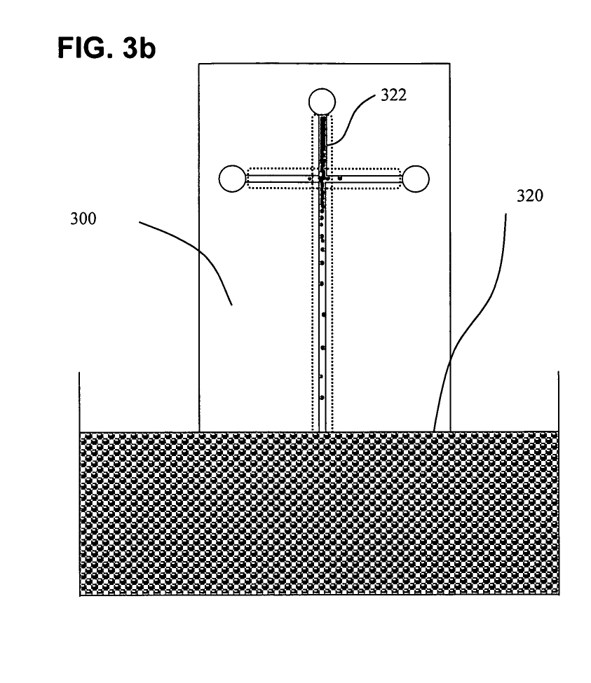

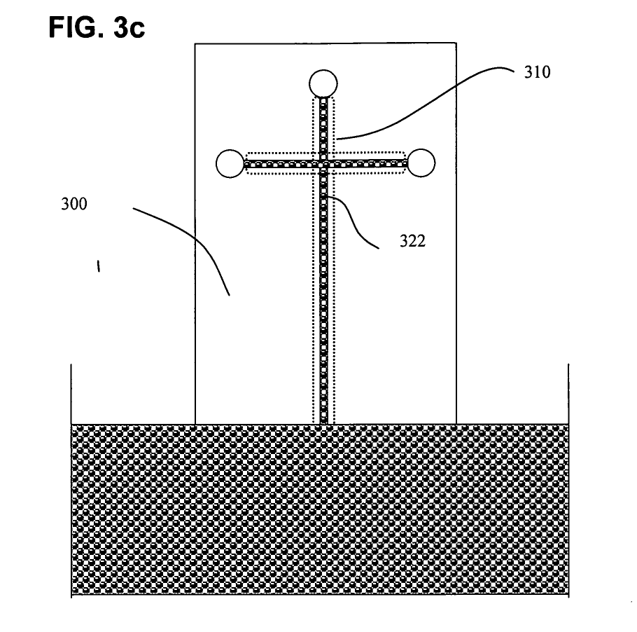

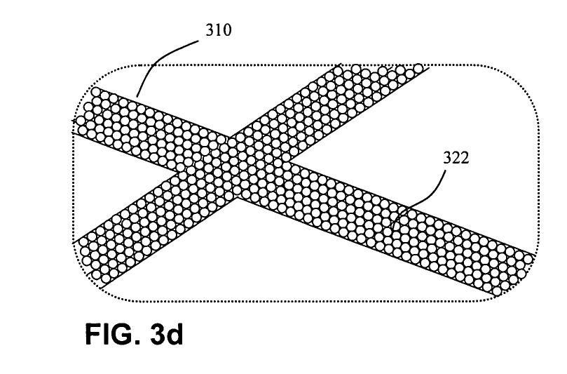

FIGS. 3a-3d show schematic illustrations for a similar process which yields fully packed microchannels instead of the selective packing described above. The process flow is analogous to the one shown in FIGS. 2a-2g—except in this case, the entire microchannel network 310 is treated to be strongly hydrophilic as shown by the plasma mask 311 in FIG. 3a. As shown in FIG. 3b upon dipping the plasma treated chip 300 into a monodispersed silica suspension in an aqueous medium, the microsphere suspension 320 is drawn up to the top and ends of the microchannels where spontaneous self-assembly of silica microspheres leading to a three dimensional array 322 is initiated during evaporation of the liquid medium.

FIG. 3c shows a schematic illustration of the fully packed chip wherein the entire microchannel network 310 is filled with the three dimensional, self-assembled silica microsphere array 322. FIG. 3e shows an expanded view of the microchannel network in the vicinity of the channel intersection, completely packed with the microsphere array 322.

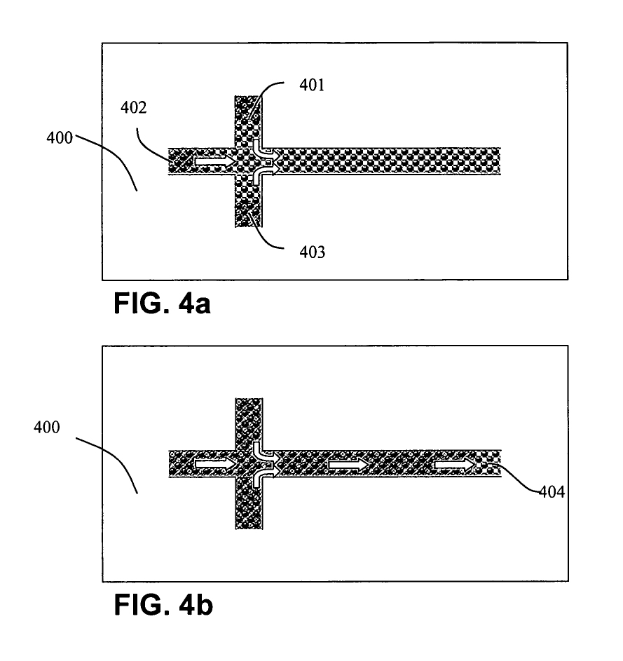

As explained previously, an essential step for CE chip operation is loading of buffer solution (also referred to as “pre-conditioning” in this disclosure). Also as mentioned previously, this step is prone to bubble formation in the microchannels due to possible cavitations within the buffer liquid column being sucked by application of negative pressure at the waste reservoir port. FIGS. 4a-4b illustrate a significant advantage of the present invention—namely the elimination of bulky pumps for vacuum loading of the buffer solutions. As shown in FIGS. 4a-4b, drops of buffer solution are placed in the sample 403, sample waste 401, and buffer reservoirs 402. Due to the extremely small dimensions and hydrophilic nature of the packed silica microsphere array, the buffer solutions are drawn into the packed microchannels by a strong capillary force. The buffer solution is sucked in from each of the three inlets and continues to flow towards the waste reservoir 404 due to capillary suction as shown in FIG. 4b.

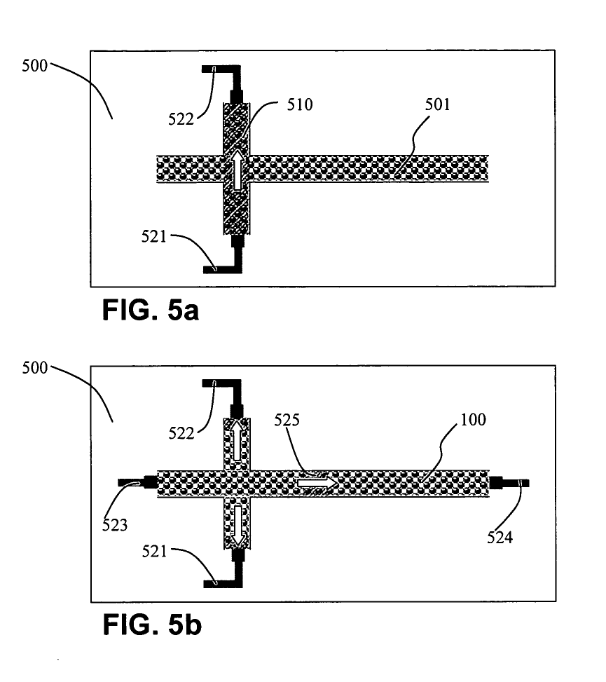

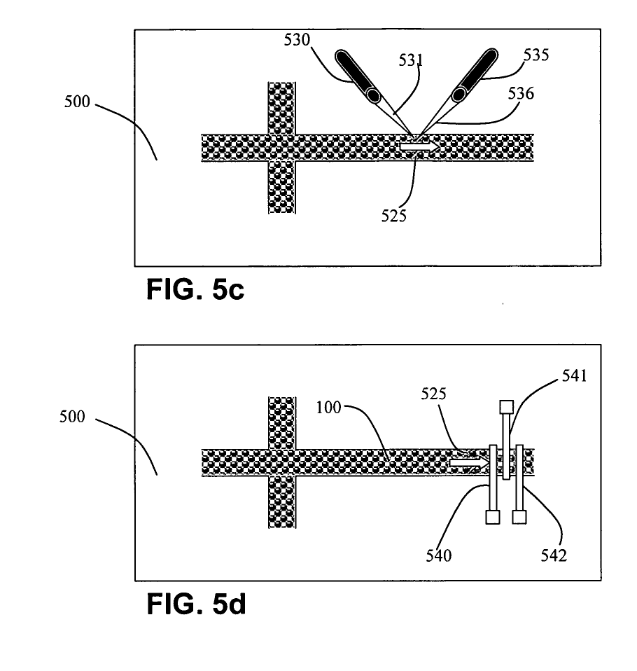

FIGS. 5a-5d show a schematic of the operational sequence of the fully packed chip 500. As shown in FIG. 5a, the desired sample solution 510 is loaded into the sample reservoir to replace the buffer (from the pre-conditioning step). A potential is applied across the sample reservoir electrode 521 and sample waste reservoir electrode 522 to load the sample by electroosmotic flow. Following this, potentials are applied to all four electrodes at the sample reservoir electrode 521, sample waste reservoir electrode 522, buffer reservoir electrode 523 and buffer waste reservoir electrode 524 as shown in FIG. 5b. The potential are adjusted such that the sample column in the loading channel is pulled back to the sample and sample waste reservoir electrodes and a small plug of the sample 525 is pulled towards the waste reservoir along the separation channel 501. As the sample plug migrates along the separation column, the constituent biochemical species within the sample are separated by CEC process.

FIG. 5c illustrates an optical detection scheme as is well known in the art. An excitation source 530 is used to used to activate the optical active components (either native or biochemical species labeled with the appropriate optical tags) using a specific wavelength 531 emission to achieve fluorescence. The fluorescence signal 536 is then detected by an optical detector 535, where the signal is proportional to the concentration and charge to mass ratio of the biochemical species of interest.

FIG. 5d illustrates an alternate detection scheme which is more suitable for point-of-care detection system. In this case, an array of microfabricated electrodes serves as an electrochemical detector. In accordance with an embodiment of the present invention, the electrochemical detector is composed of a working electrode 540, a reference electrode 542 and a counter electrode 541. The principle of operation of the electrochemical detector is widely known to those skilled in the art. In this application, the biochemical species within the sample plug 525 are labeled with an electrochemical active label or the inherent electrochemical activity of the biochemical molecules is used for detection. Since this system uses integrated microfabricated electrodes and a compact electronic detection system, it eliminates the need for a bulky, power hungry optical excitation source and the complex optical detector with its associated circuitry thereby allowing the use of the separation device as a part of a portable platform.

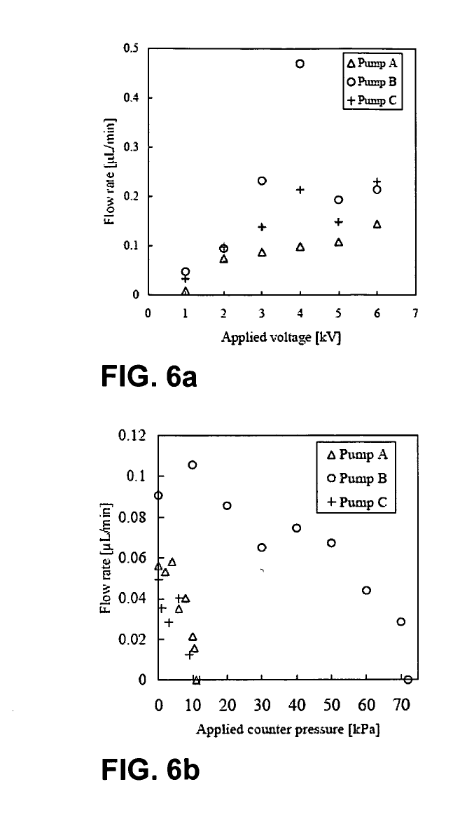

Table 1, FIGS. 6a-6b, FIG. 7 and FIG. 8 show characterization results of the fully packed chip. Table 1 shows the various physical dimensions of the microchannels that were fully packed with the silica microsphere array. Note that each different microchannel geometry is designated as a separate pump for electroosmotic pumping.

TABLE 1
The channel dimension of the electroosmotic pumps and the
result of vertical dip coating

| | | | | Dip Coating |
|---|---|---|---|---|
| PUMP ID | Length (mm) | Width (μm) | Depth (μM) | results |
| Pump A | 10 | 50 | 14 | Fully filled |
| Pump B | 10 | 50 | 26 | Fully filled |
| Pump C | 10 | 100 | 14 | Fully filled |

FIG. 6a shows the measurement results for electroosmotic flow rate versus applied potential. FIG. 6b shows the maximum pressure that can be generated by the various electroosmotic “pump” configurations. In this experiment, EOF was initiated by applying a potential to pump a buffer solution. Simultaneously, a counter pressure was applied at the outlet of the EOF flow channel. The applied counter pressure at which the applied potential can no longer sustain EOF was recorded as the maximum pressure of each of the “pumps”. As shown clearly in FIG. 6a and FIG. 6b, the packed microchannels offer excellent response for EOF pumping which is an essential step in the microfabricated separation chip operational sequence.

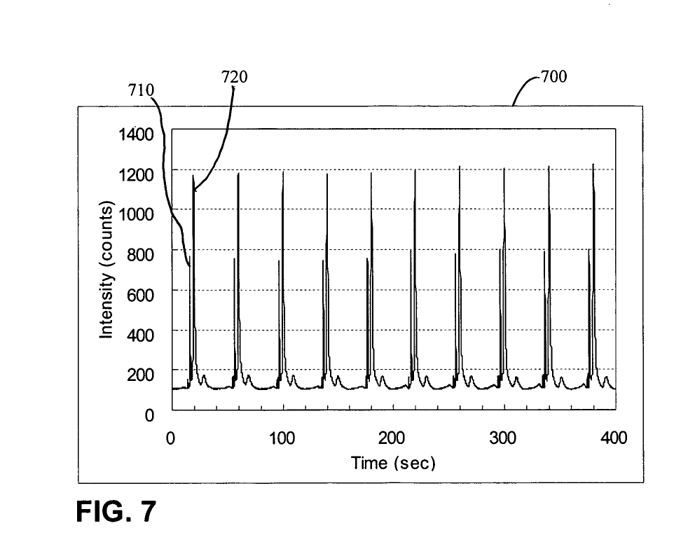

FIG. 7 shows electropherograms 700 characterizing the reproducibility of the fully packed separation device. For this experiment, the sample injection, pinching (retraction of sample solution with simultaneous formation of small sample plug at the intersection region) and separation of the sample plug in the separation channel were conducted on a periodic basis using the same device. The microchip was packed with 800 nm silica microspheres. A 20 mM sodium tetraborate buffer (pH 9.2) was used for separation. The electropherograms clearly show that the two constituent species 0.2 mM fluorescein isothiacyanate (FITC) derivatized arginine 710 and 0.5 mM fluorescein 720 mixture is clearly and reproducibly resolved using the fabricated device. Detection was achieved at 2 mm far from injection point at λ=520 nm with Xenon lamp excitation.

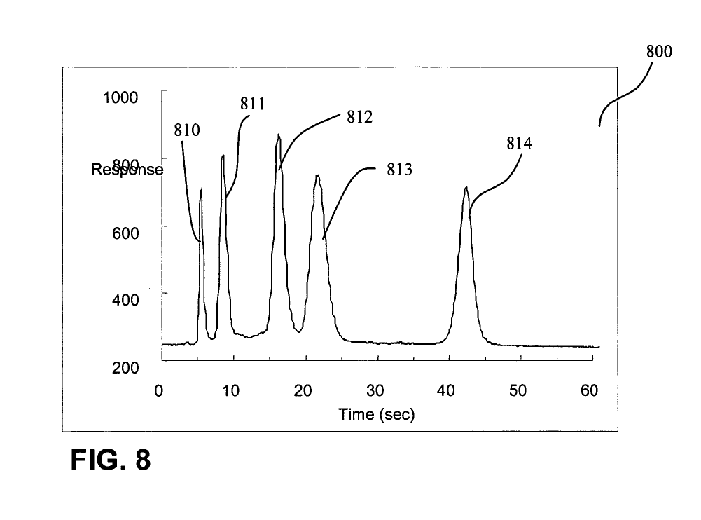

FIG. 8 shows electropherograms which demonstrate the resolving ability of the packed column chip. The electropherograms in FIG. 8 show the distinct separation between various fluorescein isothiacyanate (FITC) derivatized amino acids at a concentration of 1 mM each. The biochemical species resolved include arginine 810, FITC 811, phenylalanine 812, glycine 813, and glutamic acid 814. 20 mM sodium tetraborate buffer (pH 9.2) was used for separation. Detected at 4 mm far from injection point at X=520 nm nm with Xenon lamp excitation.

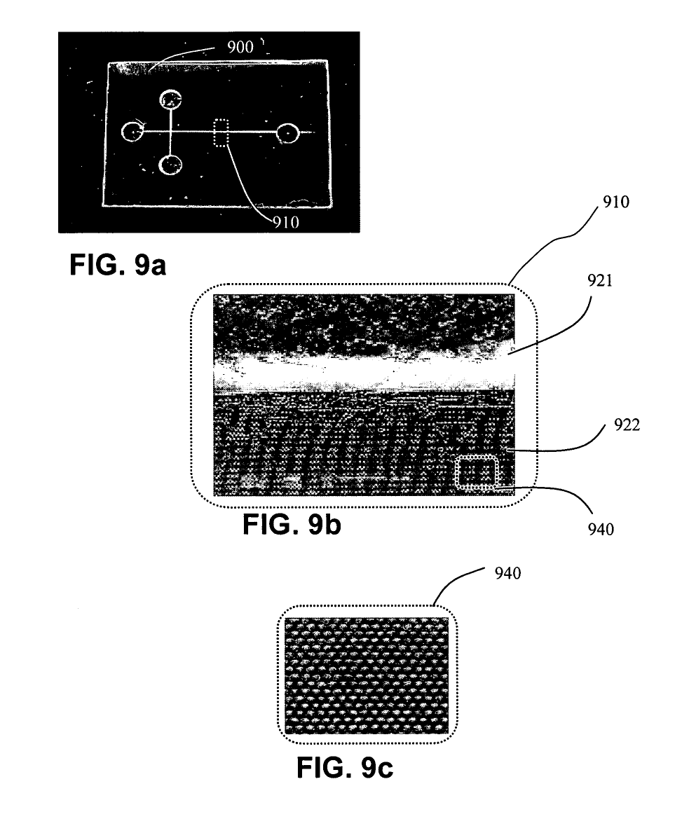

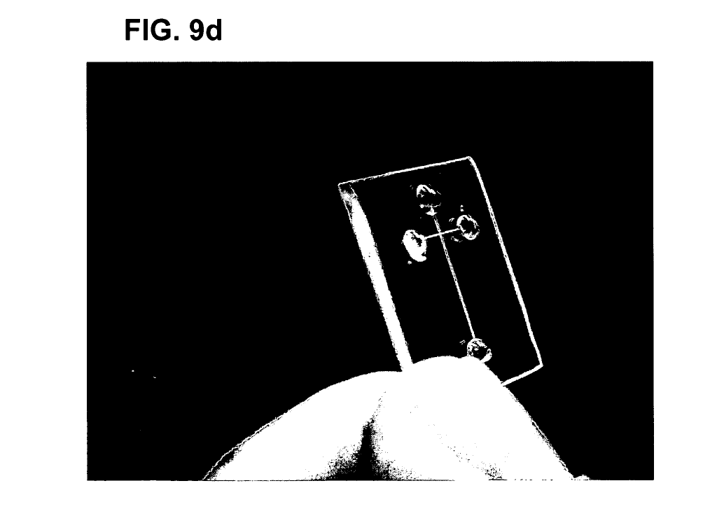

FIGS. 9a-9d show microphotographs and SEM images of the actual microfabricated chip with packed microchannel structure. FIG. 9a shows the fully assembled device 900. FIG. 9b shows a SEM image of the channel region 910 marked in FIG. 9a. FIG. 9c shows a SEM image of the region 940 marked in FIG. 9b. The SEM images clearly show the packed silica microsphere array. FIG. 9d shows a microphotograph of the assembled device 900, where buffer solution is loaded at three inlets. As shown clearly in FIG. 9d, even a substantial tilt to the chip does not allow the liquid droplets 910 to migrate over the surface of the chip due to gravitational forces lending further credence to the envisaged benefit that this device would not be susceptible to minor shocks and vibration and/or tilt effects making it ideally suitable for field applications.

From the detailed descriptions of the various embodiments of this invention a number of advantages are readily obvious including:

A simple and reliable technique for selective packing of microspheres or beads into desired regions of a microfabricated chip; wherein the said microfabricated chip can be fabricated on a multitude of substrate.

Furthermore, the use of plasma based surface modification techniques is well suited to a wide variety of substrates thereby offering the possibility of using appropriate substrate materials with desired biochemical characteristics including but not limited to biocompatibility, biochemical resistance, fouling resistance and more.

Said technique for selective or full packing of microchannels in a microfabricated device can use a wide variety of microspheres or beads including but not limited to silica particles, polystyrene beads, polysulfone beads, magnetic beads, and metallic nanoparticles to name a few. Furthermore, the microspheres or beads can be of varying diameters appropriately tailored towards the detection of specific biochemical molecules of interest.

Said technique for selective or full packing of microchannels can also use a wide variety of liquid mediums as carriers for the microparticles to form a suspension solution. Such solutions would include but are not limited to aqueous solutions, solvents such as acetone, methanol, isoproponal and more.

The use of selective packing in the microchannels allows for control over the length of the packed column and in part control over the separation channel (i.e. whether it is fully packed or partially packed) thereby leading to optimum separation characteristics.

The use of the selective packing techniques together with the wide choice of packing materials allow for the development of a generic microfabricated separation chip wherein the microchannel network is maintained yet the separation characteristics can be modified by varying the length of the packed column, the porosity of the packed column, and the material of the packed columns.

The techniques disclosed in this invention allow for the fabrication of a low-cost, disposable analysis chip on a plastic substrate using reliable and easy fabrication processes for microsphere packing.

The packed bead or microsphere column allows for uniform EOF which is critical for rapid and reliable separations.

The packed bead column dramatically enhances the surface area to volume ratio thereby permitting more rapid and reliable separations by use of higher separation potentials.

Since no negative pressure is needed for buffer loading the requirement for bulky pumps is eliminated thereby making the device more suitable for point-of-care testing applications wherein smaller physical size of the overall system is highly desirable.

Furthermore, the elimination of negative pressure for loading also precludes the possibility of air bubble being formed and impairing the operation of the chip.

An additional advantage of this approach is that owing to the strong capillary suction force exerted by the packed silica microsphere array; the liquid column in not susceptible to small differences in pressure at the various inlets that can be caused by gravitational forces if the chip is not properly leveled. The robust operating characteristics; namely the elimination of a perfectly level surface for operation is also highly desirable for field applications and/or point-of-care testing.

Yet another advantage of this approach is the ability to develop pre-conditioned chips wherein the buffer sample is already loaded during the manufacturing step. Owing to the high surface tension forces exerted by the packed bead column, such a chip can be stored under optimal conditions without significant loss in buffer volume and can be readily used for analysis without any buffer loading step.

Yet another advantage of this approach is the elimination of sub-micron filtration requirements owing to inherent filtering capability of the packed bead columns.

Yet another advantage of this approach is the ability to work with complex biological solutions such as whole blood, with minimal sample prep, owing to the inherent filtering capability of the packed channels which will eliminate interference due to cellular components of whole blood.

It would be readily obvious to those skilled in the art that modifications or variations may be made to the embodiments and variations thereof, described herein without departing from the essential novelty of the present invention. All such modifications and variations are intended to be incorporated herein and within the scope of the following claims.

What is claimed is:

1. A microfluidic method, said method comprising:
packing a submicron colloidal microsphere array or bead array, using a self-assembly technique, into at least one selected region of at least one microchannel on a disposable plastic microchip, and wherein said at least one selected region has a modified, substantially hydrophilic surface.

2. The method of claim 1 wherein said microchip comprises an electrokinetic device used for Capillary Electrochromatography.

3. The method of claim 1 wherein said microsphere array or bead array fills predetermined regions of said at least one microchannel patterned on a plastic substrate of said microchip.

4. The method of claim 1 wherein said microsphere array or bead array fills said entire at least one microchannel patterned on a plastic substrate of said microchip forming a fully-packed microchannel.

5. The method of claim 1 wherein said plastic is selected from the group consisting of thermoplastic polymers including but not limited to Cyclic Olefin Copolymers, Poly-Methylmethaacrylate, and Polycarbonate.

6. The method of claim 1 wherein said at least one microchannel comprises a predefined structure in a plastic substrate.

7. The method of claim 1 wherein a plasma treatment is used to make said at least one selected region hydrophilic.

8. The method of claim 1 wherein said self-assembly technique comprises:
performing a dry or wet surface treatment of a microchannel patterned plastic substrate of said microchip to define said at least one selected region as a hydrophilic surface; and
providing three-dimensional colloidal particles to the at least one selected region such that said particles self-assemble in said at least one selected region in a well-ordered manner.

9. The method of claim 8 wherein said self-assembled particles range in size from 100 nanometers to 1 micrometer.

10. The method of claim 8 wherein said self-assembled particles range in size from 1 micrometer to 10 micrometers.

11. The method of claim 8 wherein said self-assembled particles range in size from 10 micrometers to 100 micrometers.

12. The method of claim 8 wherein said self-assembled particles comprise silica.

13. The method of claim 8 wherein said self-assembled particles comprise at least one of polystyrene, polysulfone, polymer beads with embedded magnetic particles, and metallic nanoparticles.

14. The method of claim 8 wherein said particles for self-assembly initially comprise microspheres or beads suspended in an aqueous solution.

15. The method of claim 8 wherein said particles for self-assembly initially comprise microspheres or beads suspended in a non-polar solvent including but not limited to at least one of acetone, methanol, and isopropanol.

16. The method of claim 8 wherein said particles for self-assembly initially comprise microspheres or beads suspended in a medium that does not react with the microspheres or beads and a plastic substrate of said microchip.

17. The method of claim 1 wherein said disposable microchip comprises a generic device wherein a microfabricated geometry is predefined and electrokinetic characteristics are altered by altering a length of a packed column of said microsphere array or said bead array.

18. The method of claim 1 wherein said disposable microchip comprises a generic device wherein a microfabricated geometry is predefined and electrokinetic characteristics are altered by altering a material of a packed column of said microsphere array or said bead array.

19. The method of claim 1 wherein said disposable microchip comprises a generic device wherein a microfabricated geometry is predefined and electrokinetic characteristics are altered by altering a porosity of a packed column of said microsphere array or said bead array.

20. The method of claim 1 wherein said packed microchannel comprises a chromatographic column for capillary electrochromatography (CEM) that provides for a separation of various target substances by both electrophoretic mobility and partitioning between a stationary phase and a mobile phase.

21. The method of claim 1 wherein said packed microchannel supports:
a preparation of various chromatographic stationary support packings;
a preparation of an electrochromatography based microchip by functionalizing a surface of packed beads;
a preparation of a pre-derivatized chromatographic stationary phase in a microchannel on a chip; and
a preparation of a built-in submicron filter.

22. The method of claim 1 further comprising an injection technique, which is a capillary force-driven technique, for a buffer solution and samples.

23. The method of claim 1 wherein electrokinetic characteristics of said microchip are not affected by small differences in pressures at various inlets of said microchip caused by gravitational forces acting on said microchip when said microchip is not level.

24. A disposable plastic microchip, said microchip comprising:
at least one microchannel packed with a submicron colloidal microsphere array or bead array using a self-assembly technique, and wherein said at least one microchannel has a modified, substantially hydrophilic surface over a natural, substantially hydrophobic surface of a substrate of said microchip.

25. The microchip of claim 24 wherein said microchip comprises an electrokinetic device used for Capillary Electrochromatography.

26. The microchip of claim 24 wherein said microsphere array or bead array fills said entire at least one microchannel patterned on a plastic substrate of said microchip forming a fully-packed microchannel.

27. The microchip of claim 24 wherein said plastic is selected from the group consisting of thermoplastic polymers including but not limited to Cyclic Olefin Copolymers, Poly-Methylmethaacrylate, and Polycarbonate.

28. The microchip of claim 24 wherein said at least one microchannel comprises a predefined structure in a plastic substrate.

29. The microchip of claim 24 wherein said self-assembly technique comprises:
performing a dry or wet surface treatment of a microchannel patterned plastic substrate of said microchip to define said hydrophilic surface; and
providing three-dimensional colloidal particles to at least one microchannel such that said particles self-assemble in said at least one microchannel in a well-ordered manner.

30. The microchip of claim 29 wherein said self-assembled particles range in size from 100 nanometers to 1 micrometer.

31. The microchip of claim 29 wherein said self-assembled particles range in size from 1 micrometer to 10 micrometers.

32. The microchip of claim 29 wherein said self-assembled particles range in size from 10 micrometers to 100 micrometers.

33. The microchip of claim 29 wherein said self-assembled particles comprise silica.

34. The microchip of claim 29 wherein said self-assembled particles comprise at least one of polystyrene, polysulfone, polymer beads with embedded magnetic particles, and metallic nanoparticles.

35. The microchip of claim 29 wherein said particles for self-assembly initially comprise microspheres or beads suspended in an aqueous solution.

36. The microchip of claim 29 wherein said particles for self-assembly initially comprise microspheres or beads suspended in a non-polar solvent including but not limited to at least one of acetone, methanol, and isopropanol.

37. The microchip of claim 29 wherein said particles for self-assembly initially comprise microspheres or beads suspended in a medium that does not react with the microspheres or beads and a plastic substrate of said microchip.

38. The microchip of claim 24 wherein said disposable microchip comprises a generic device wherein a microfabricated geometry is predefined and electrokinetic characteristics are altered by altering a length of a packed column of said microsphere array or said bead array.

39. The microchip of claim 24 wherein said disposable microchip comprises a generic device wherein a microfabricated geometry is predefined and electrokinetic characteristics are altered by altering a material of a packed column of said microsphere array or said bead array.

40. The microchip of claim 24 wherein said disposable microchip comprises a generic device wherein a microfabricated geometry is predefined and electrokinetic characteristics are altered by altering a porosity of a packed column of said microsphere array or said bead array.

41. The microchip of claim 24 wherein said packed microchannel supports:
a preparation of various chromatographic stationary support packings;
a preparation of an electrochromatography based microchip by functionalizing a surface of packed beads;
a preparation of a pre-derivatized chromatographic stationary phase in a microchannel on a chip; and
a preparation of a built-in submicron filter.

42. The microchip of claim 24 wherein an injection technique is used, which is a capillary force-driven technique, for a buffer solution and samples.

43. The microchip of claim 24 wherein electrokinetic characteristics of said microchip are not affected by small differences in pressures at various inlets of said microchip caused by gravitational forces acting on said microchip when said microchip is not level.

44. A microfluidic device comprising a body structure having a microfluidic channel disposed therein, wherein the microfluidic channel comprises a substantially hydrophobic section, a substantially hydrophilic section adjacent to and in communication with the substantially hydrophobic section, and a self-assembled colloidal array of particles disposed within the substantially hydrophilic section.
